(19) United States
(12) Patent Application Publication
(10) Pub. No.: US 2010/0125694 A1
(43) Pub. Date: May 20, 2010

(54) MEMORY DEVICE AND MANAGEMENT METHOD OF MEMORY DEVICE

(76) Inventor: Gyu Sang Choi, Seoul (KR)

Correspondence Address: North Star Intellectual Property Law, PC, P.O. Box 34688, Washington, DC, 20043, US

(21) Appl. No.: 12/418,088

(22) Filed: Apr. 3, 2009

(30) Foreign Application Priority Data
Nov. 18, 2008 (KR) 10-2008-0114351

(51) Int. Cl. G06F 12/02; G06F 12/06

(52) U.S. Cl. 711/1; 711/103; 711/E12.008; 711/E12.078

(57) ABSTRACT

A memory device and a method for managing the memory device is provided. The memory device includes a flash memory including a plurality of pages, a non-volatile RAM storing a first mapping table between a physical page address and a logical page address for each page of the plurality of pages, and a volatile RAM storing a second mapping table between the physical page address and the logical page address for each page of the plurality of pages.

### CROSS-REFERENCE TO RELATED APPLICATION

This application claims the benefit under 35 U.S.C. §119(a) of a Korean Patent Application No. 10-2008-0114351, filed on Nov. 18, 2008 in the Korean Intellectual Property Office, the entire disclosure of which is incorporated herein by reference.

### BACKGROUND

1. Field

The following description relates to a memory device and a method for managing the memory device, and more particularly, to a non-volatile memory-based memory device and a method for managing the memory device.

2. Description of Related Art

A non-volatile memory device is able to electronically read, write, and erase data. Further, a non-volatile memory device may be a semiconductor device that is able to maintain stored data even when power is cut off. The process of storing data in a non-volatile memory device may be referred to as programming or writing.

In addition, non-volatile memory, particularly NAND flash memory, has a read time and a write time. Typically, the read time of NAND flash memory takes several tens of microseconds per kilobyte and the write time takes several hundred microseconds per kilobyte. Also, NAND flash memory may have an erase time that is different from the write time. Since the erase time is generally around several milliseconds, a method of erasing a plurality of memory cells at the same time is widely used to reduce the erase time with respect to the entire data. Further, a unit of the plurality of memory cells that are simultaneously erased may be an erase unit or a block.

Programming with respect to a non-volatile memory device may be performed in page units, and erasing may be performed in block units. A block may include a plurality of pages. A non-volatile memory device may provide a logical address to an external host or processor, and may also provide a physical address with respect to a non-volatile memory device. Management of a non-volatile memory device may use the physical address and may convert the physical address into the logical address. A layer where converting of the physical address and logical address is performed may be referred to as a Flash Translation Layer.

A method that manages a relationship between a logical address and a physical address for each page of a flash memory as metadata may be referred to as a page-level mapping.

### SUMMARY

General examples include a memory device that may effectively manage a mapping table for a page-level mapping of a non-volatile memory and a method for managing the memory device.

Examples may also provide a memory device having a downsized space for storing metadata of a non-volatile RAM and a method for managing the memory device.

In one general aspect, there is provided a memory device including a flash memory including a plurality of pages, a non-volatile RAM storing a first mapping table between a physical page address and a logical page address for each page of the plurality of pages, and a volatile RAM storing a second mapping table between the physical page address and the logical page address for each page of the plurality of pages.

The first mapping table may be used for converting the physical page address into the logical page address, and the second mapping table may be used for converting the logical page address into the physical page address. The first mapping table may be arranged according to the physical page address, and the second mapping table may be arranged according to the logical page address.

The second mapping table may be generated by reconstructing the first mapping table. In response to the memory device being booted up, the first mapping table may be read from the non-volatile RAM and reconstructed to generate the second mapping table, and the second mapping table may be stored in the volatile RAM.

wherein response to first data stored in a first page of the plurality of pages being updated, second data which is an updated value of the first data may be stored in a second page in the flash memory, the second page being empty prior to the storing of the second data, and a logical address of the first page may be stored as a logical address corresponding to a physical address of the second page in the first mapping table.

A physical address corresponding to the logical address of the first page, the physical address being in the second mapping table, may be converted from the physical address of the first page into the physical address of the second page.

In response to an erase count of the non-volatile RAM being determined, an erase count of the flash memory stored in the flash memory may be determined as an erase count of the non-volatile RAM. The non-volatile RAM may be phase change random access memory (PRAM).

In response to a first block and a second block from among the plurality of the blocks being merged, the flash memory may assign a third block, the third block being empty, and respectively stores data for each valid page of the first block and data for each valid page of the second block in a plurality of pages of the third block.

The memory device may store “NULL” to indicate that information for a logical address corresponding to a physical address for each valid page of the first block in the first mapping table does not exist, store “NULL” to indicate that information for a logical address corresponding to a physical address for each valid page of the second block in the first mapping table does not exist, and determine and store a value corresponding to a physical address for each page of the third block in the first mapping table based on a logical address for each valid page of the first block and a logical address for each valid page in the second block.

According to another general aspect, there is provided a memory device including a flash memory including a plurality of data blocks and at least one metadata block, wherein the flash memory stores first metadata corresponding to the plurality of data blocks in the metadata block, and each of the plurality of data blocks includes a plurality of pages; and a non-volatile RAM storing second metadata corresponding to the plurality of data blocks, wherein an erase count of the non-volatile RAM is determined by the first metadata.

The first metadata may include an erase count for each of the plurality of data blocks, and the second metadata includes a first mapping table between a physical address and a logical address for each of the plurality of pages.

According to another general aspect, there is provided a method for managing a memory, the method including storing a first mapping table between a physical page address and a logical page address for each of a plurality of pages in a flash memory, and generating a second mapping table between the physical page address and the logical page address for each of the plurality of pages by reconstructing the first mapping table read from the flash memory, in response to a memory device including the flash memory being booted up.

The first mapping table may be used for converting the physical page address into the logical page address, and the second mapping table is used for converting the logical page address into the physical page address.

In response to first data stored in a first page from among the plurality of pages being updated, the method may further include storing second data which is an updated value of the first data, in a second page of the flash memory, the second page being empty prior to the storing of the second data, storing a logical address of the first page as a logical address corresponding to a physical address of the second page in the first mapping table, and converting a physical address corresponding to the logical address of the first page, the physical address being in a second mapping table, from a physical address of the first page into the physical address of the second page.

In response to an erase count of a first word of the non-volatile RAM being determined, the method may further include reading first metadata including an erase count of the flash memory, searching for a first block corresponding to the first word from among the plurality of blocks of the flash memory using the first mapping table, and determining an erase count of the first block as the erase count of the first word of the non-volatile RAM.

According to another general aspect, a computer-readable storage medium storing a program for managing a memory, may include instructions to cause a computer to store a first mapping table between a physical page address and a logical page address for each of a plurality of pages in a flash memory, and generate a second mapping table between the physical page address and the logical page address for each of the plurality of pages by reconstructing the first mapping table read from the flash memory, in response to a memory device including the flash memory being booted up.

Other features and aspects will be apparent from the following detailed description, the drawings, and the claims.

### BRIEF DESCRIPTION OF THE DRAWINGS

FIG. 1 is a diagram illustrating an exemplary a memory device.

FIG. 2 is a diagram illustrating an exemplary process of reconstructing a first mapping table to generate a second mapping table, and storing the second mapping table in a volatile RAM, in a memory device.

FIG. 3 is a diagram illustrating an exemplary process of merging two full blocks, in a memory device.

FIG. 4 is a flowchart illustrating an exemplary memory management method.

FIG. 5 is a flowchart illustrating an exemplary method of updating a first page of a memory device.

FIG. 6 is a flowchart illustrating an exemplary method of merging two blocks.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions are omitted to increase clarity and conciseness.

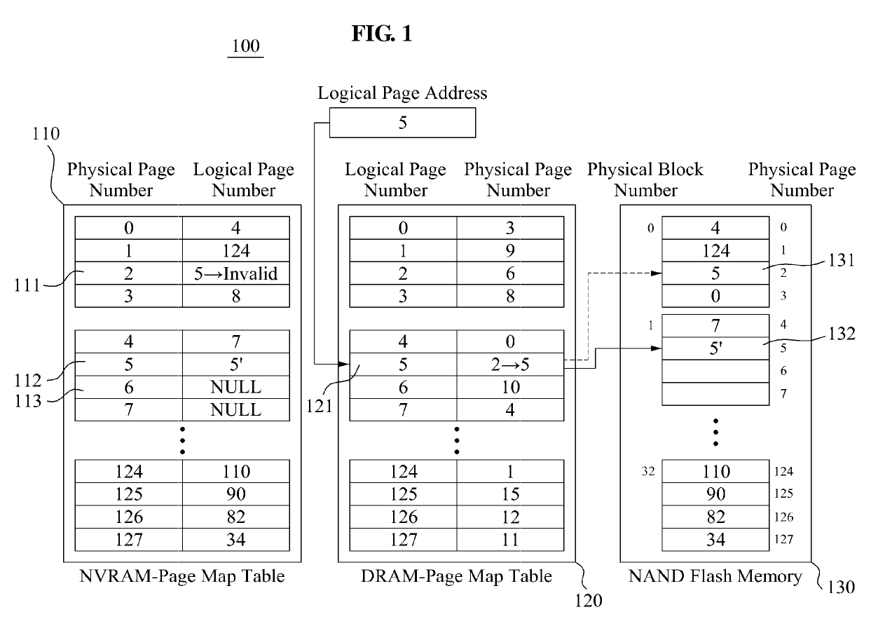

FIG. 1 illustrates an exemplary memory device.

According to one example, the memory device 100 includes a non-volatile RAM 110, a volatile RAM 120, and a flash memory 130.

The memory device 100, may be a solid state disk (SSD) including a flash memory. The SSD is a device embodying a storage having large-capacity using a plurality of flash memory chips.

According to exemplary embodiments, the non-volatile RAM 110 may be a phase change random access memory (PRAM) or ferromagnetic random access memory (FRAM).

PRAM is a non-volatile RAM that may store data according to a phenomenon that a state of a specific material is changed into a crystal state or a non-crystal state by applying an electric current to the material. In PRAM, a germanium antimony telluride (GST) may be used. However, in the case of PRAM, while a number of reads of data may not be limited, a number of writes (or erases) of data may be limited. As an example, data may be written or erased by word units in the PRAM, and a number of erases of each word may be limited to about 1,000,000 times.

FRAM is a non-volatile RAM that stores information by applying an electric field to a ferromagnetic thin capacitor, and then sensing remaining polarization(2Pr or sensing margin) with 0(zero) electric field.

The flash memory 130 may be either a NAND flash memory or a NOR flash memory. Although herein describes the case that the flash memory is the NAND flash memory, it is merely one example and other examples may not be limited thereto.

The flash memory 130 includes a plurality of blocks, and each of the plurality of blocks includes a plurality of pages.

In addition, the NAND flash memory may have several unique characteristics. One of the unique characteristics is that mapping information between a physical page address and a logical page address is required. The mapping information may be stored in a form of a page mapping table. Also, the page mapping table is managed as a portion of metadata related to the NAND flash memory.

Also, another characteristic of the NAND flash memory is an erase before write characteristic. That is, where first data stored in a first page of the plurality of pages of the NAND flash memory is updated, second data which is an updated value of the first data may be written in the first page only after the first page is erased.

In addition, the NAND flash memory has a read time which takes several tens of microseconds per kilobyte and a write time which takes several hundred microseconds per kilobyte, whereas the erase time is up to several milliseconds.

Accordingly, after erasing the page, writing new data in the first page to update the first page of the flash memory may expend substantial time, thereby having low efficiency. Therefore, a method that stores the second data which is an updated value of the first data of the first page, in an empty second page, and changes a physical address corresponding to a logical address of the first page in the page mapping table from a physical address of the first page into a physical address of the second page, may be used.

Also, a state of the first page may be subsequently stored as invalid. However, in response to erasing a block containing the first page, the first page is erased together with the other pages contained in the block. The above process is a portion of a page-level mapping scheme.

According to one example, the first mapping table between a physical page address and logical page address for each of the plurality of pages of the flash memory 130 is stored in a non-volatile RAM 110. Since the first mapping table is arranged with respect to the physical page address, in response to a predetermined physical address being inputted, a logical page address corresponding to the physical page address may be provided without scanning.

However, a second mapping table between the logical page address and the physical page address for each of the plurality of pages of the flash memory 130 may be stored in the non-volatile RAM 120. Since the second mapping table may be arranged with respect to the logical page address, a predetermined logical page address may be inputted, and a physical page address corresponding to the logical page address may be provided.

According to one example, a second mapping table stored in the volatile RAM 120 may be erased in response to power of the memory device 100 being off and electric power not being supplied. Also, in response to the memory device 100 being provided with electric power, the first mapping table may be stored in the volatile RAM 120 by, for example, reconstructing and generating the first mapping table during a time for booting up.

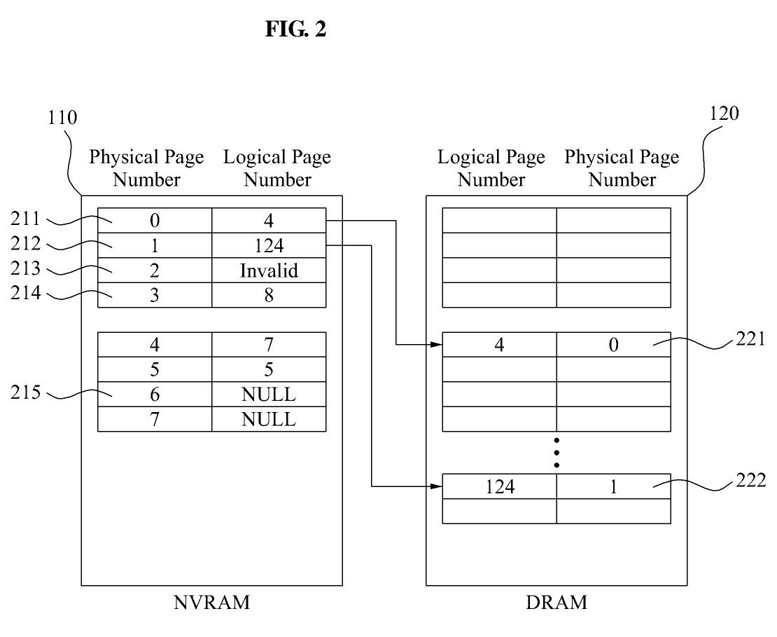

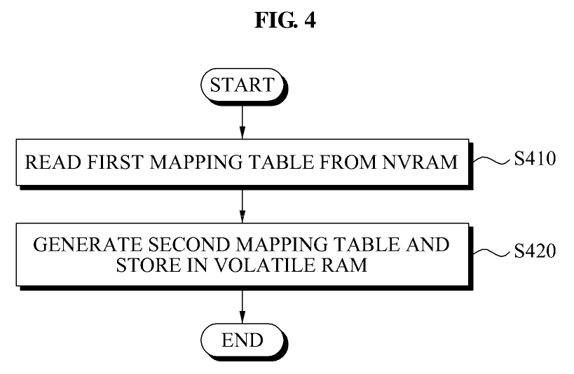

A process of reading the first mapping table from the non-volatile RAM 110, reconstructing the first mapping table to generate second mapping table, and storing the generated second mapping table in the volatile RAM 120 will be described later with reference to FIGS. 2 and 4.

According to one example, in response to a first data stored in a page having a logical address “5” being updated to include a second data, the memory device 100 may be provided with a physical address “2”, with reference to an entry 121 corresponding to the logical address “5” in the second mapping table.

Also, state information of a first page 131 having the physical page address, “2” in the flash memory 130 may be ascertained. The first page 131 may not be empty.

The memory device 100 may assign a second page 132 which is empty, and may store the second data in the second page 132.

Also, the memory device 100 may access a first table of the non-volatile RAM 110, and may store a logical page address “5”, which relates to the second page, in an entry 112 corresponding to a physical page address “5”, of the second page 132.

However, the memory device 100 may access a second table of the volatile RAM 120, and may change the physical page address stored in the entry 121 corresponding to the logical page address “5”, from “2” to “5”.

According to one example, a number of erases of each word of the non-volatile RAM 110 is not separately stored. In response to information for the number of erases of each word being needed to be obtained for performing wear leveling of the non-volatile RAM 110, for example, PRAM, the memory device 100 may obtain the number of erases of each word of the non-volatile RAM using a number of erases of each block of the flash memory 130.

As an example, the number of erases of a word corresponding an entry 111 is the same as a number of erases of page 131 of the flash memory. Therefore, the memory device 100 determines the number of erases of a block (a physical block number of the block is “0”) including the page 131 as the number of erases of the word corresponding to the entry 111 of the non-volatile RAM.

FIG. 2 illustrates an exemplary process of reconstructing a first mapping table to generate a second mapping table, and storing the second mapping table in a volatile RAM, in a memory device.

In response to the memory device 100 being booted up, the memory device 100 may read the first mapping table stored in the non-volatile RAM 110.

The memory device 100 may read a logical page address “4” corresponding to a physical page address “0”, from an entry 211 of the non-volatile RAM 110. Also, the memory device 100 may store the physical page address “0” in an entry 221 corresponding to a logical page address “4” of the second mapping table of a volatile RAM 120.

Also, the memory device 100 may read a logical page address, “124” corresponding to a physical address “1” from an entry 212 of the non-volatile RAM 110. Also, the memory device 100 may store the physical page address “1” in an entry 222 corresponding to a logical page address “124” of the second mapping table of the volatile RAM 120.

Also, the memory device 100 may read a logical page address corresponding to a physical page address “2” from an entry 213 of the non-volatile RAM 110. Since the physical page address “2” is invalid, the memory device 100 may repeat the described process with respect to a subsequent entry 214.

However, in response to the memory device 100 finding a “NULL” of a logical page address corresponding to a physical page address “0” during the process, the memory device 100 may continue to perform the process with respect to a next entry.

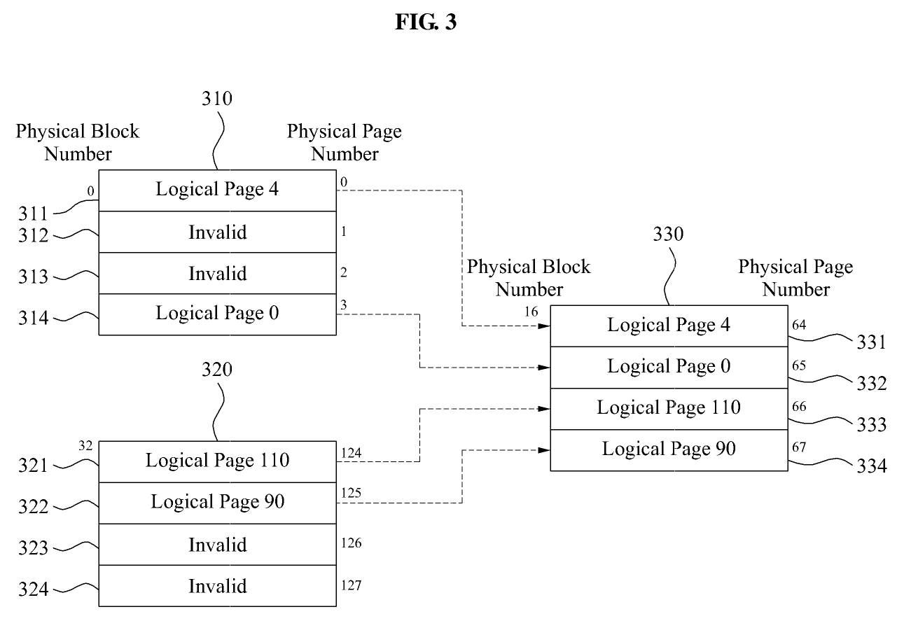

FIG. 3 illustrates an exemplary process of merging two full blocks, in a memory device.

A block 310, having a physical block number “0”, and a block 320, having a physical block number “32”, may be merged.

The memory device 100 may assign an empty block 330 having a block number “16”.

Also, the memory device 100 may copy data stored in a page 311 of the block 310 to a page 331 of the block 330.

Also, pages 312 and 313 of the block 310, which are invalid, are skipped, and data stored in the block 314 may be copied to a page 332 of the block 330.

Also, the memory device may copy data stored in a page 321 of the block 320 to a page 333 of the block 330, and may copy data stored in 322 to a page 334. As described above, pages 323 and 324 which are invalid may be skipped.

The above-described process may be repeated until all the valid data in two blocks 310 and 320 to be merged are copied.

The memory device 100 may update a first mapping table stored in the non-volatile memory 110. In this case, the memory device 100 respectively may store logical addresses, “4”, “0”, “110” and “90” to entries respectively corresponding to a physical addresses, “64”, “65”, “66”, and “67” from among entries in the first mapping table.

The memory device 100 may update a second mapping table stored in the volatile RAM 120. A physical addresses “64”, “65”, “66”, and “67” may be respectively stored in entries respectively corresponding to logical addresses “4”, “0”, “110”, and “90” from among entries in the second mapping table.

Although one example describes that the first mapping table is updated and then the second mapping table is updated with reference to the first mapping table, in another example the sequence for updating may be changed.

According to one example, in response to a valid page being copied, the first mapping table and the second mapping table may be updated and a subsequent valid page may be copied.

FIG. 4 is a flowchart illustrating an exemplary memory management method. Referring to FIG. 1, a first mapping table is stored in a non-volatile RAM (NVRAM) 110 of a memory device 100.

In operation S410, in response to the memory device 100 being booted up, the memory device 100 may read the first mapping table from the NVRAM 110. The memory device 100 may read logical page addresses corresponding to physical page addresses from each entry 211 of the NVRAM 110.

In operation S420, the memory device 100 stores the physical addresses corresponding to the logical addresses in a second mapping table of a volatile RAM 120 respectively corresponding to the physical page addresses of the first mapping table.

An exemplary process of generating and storing the second mapping table has been already described with reference to FIG. 2.

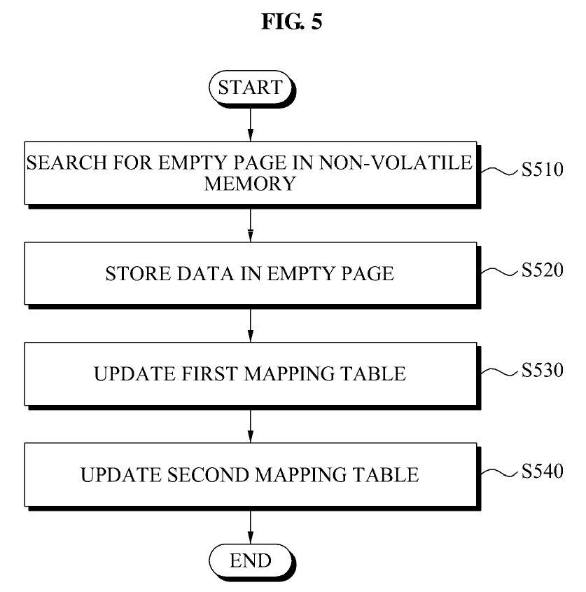

FIG. 5 is a flowchart illustrating an exemplary method of updating a first page of a memory device.

Referring to FIG. 1, the memory device 100 records second data in a logical address “5”. The memory device 100 may ascertain a physical address corresponding to the logical address “5” from an entry 121 of a second mapping table stored in a volatile RAM 120. Also, the memory device 100 may ascertain a status of a physical page address “2” of a flash memory 130. The page 131 may not be clean. That is, the physical address corresponding to the logical address “5” of the entry 121 may be the physical address “2”, and first data is stored in the page 131 corresponding to the physical address “2”. Accordingly, a new page may be assigned.

The memory device 100 may search for an empty page in the flash memory 130 in operation S510. A page 132 may be assigned, as one example, as shown in FIG. 1.

In operation S520, the second data may be stored in the page 132. A first mapping table of the NVRAM 110 may be updated in operation S530. A logical address “5” in an entry 111 corresponding to a physical address “2” of the first mapping table may be changed into invalid. Also, a logical page address of an entry 112 corresponding to a physical page address “5” may be changed from “NULL” to “5”.

In operation S540, the second mapping table of the volatile RAM 120 may be updated. The physical address of the entry 121 corresponding to the logical address, “5”, may be changed from “2” to “5”.

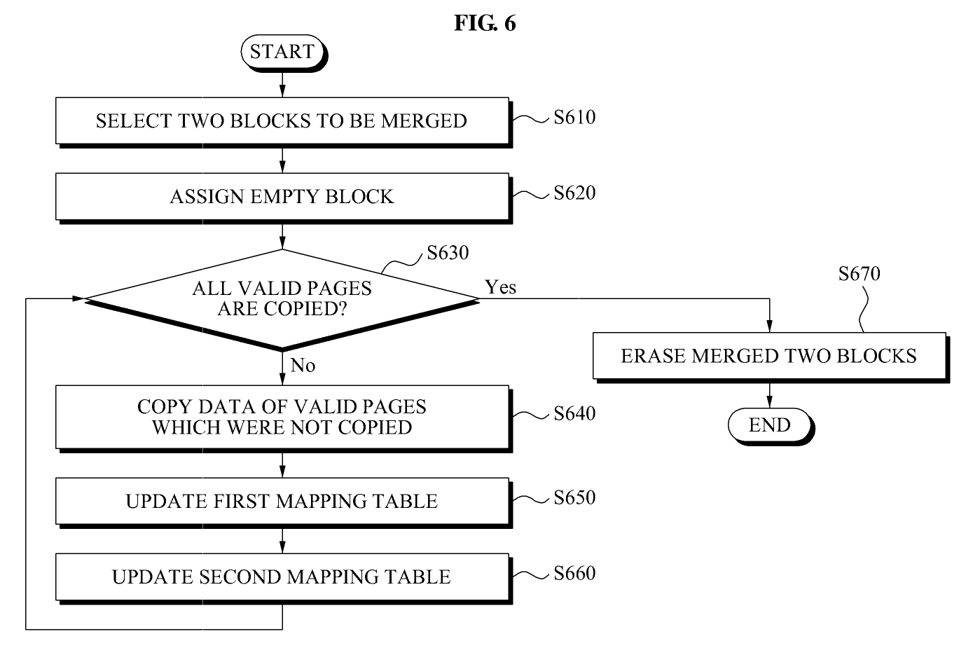

FIG. 6 is a flowchart illustrating an exemplary method of merging two blocks.

In operation S610, two blocks to be merged may be selected. Referring to FIG. 3, the two blocks to be merged may be a block 310 and a block 320.

In operation S620, an empty block 330 may be newly assigned.

In operation S630, whether all valid pages in the two blocks to be merged are copied may be determined.

In operation S640, in response to the result of the determination being “NO”, valid pages which are not copied in the two blocks to be merged may be copied to empty pages of the newly assigned block.

In operation S650, a first mapping table in the NVRAM 110 of FIG. 1 may be updated. Referring to FIG. 3, a logical address corresponding to a physical address “0” of a page 311 may be changed to “NULL” in the mapping table. Also, a logical address “4” may be stored in a logical address corresponding to a physical address “64”.

In operation S660, a second mapping table in the volatile RAM 120 may be updated. The physical address “64”, corresponding to the logical address “4”, may be stored in the second mapping table.

Where all valid pages are copied by repeating operations S640 through S660, the blocks 310 and 320 which are merged may be erased in operation S670.

The methods described above may be recorded, stored, or fixed in one or more computer-readable media including program instructions to be implemented by a computer to cause a processor to execute or perform the program instructions. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Flash memory devices and/or memory controllers according to the examples described above may be included in various types of packages. For example, the flash memory devices and/or memory controllers may be embodied using packages such as Package on Packages (PoPs), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Quad Flatpack (QFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The flash memory devices and/or the memory controllers may constitute memory cards. In this case, the memory controllers may be constructed to communicate with an external device for example, a host using any one of various types of interface protocols such as a Universal Serial Bus (USB), a Multi Media Card (MMC), a Peripheral Component Interconnect-Express (PCI-E), Serial Advanced Technology Attachment (SATA), Parallel ATA (PATA), Small Computer System Interface (SCSI), Enhanced Small Device Interface (ESDI), and Integrated Drive Electronics (IDE).

The flash memory devices may be non-volatile memory devices that can maintain stored data even when power is cut off. According to an increase in the use of mobile devices such as a cellular phone, a personal digital assistant (PDA), a digital camera, a portable game console, and an MP3 player, the flash memory devices may be more widely used as data storage and code storage. The flash memory devices may be used in home applications such as a high definition television (HDTV), a DVD, a router, and a Global Positioning System (GPS).

A computing system according to the examples described above may include a microprocessor that is electrically connected with a bus, a user interface, a modem such as a baseband chipset, a memory controller, and a flash memory device. The flash memory device may store N-bit data via the memory controller. The N-bit data is processed or will be processed by the microprocessor and N may be 1 or an integer greater than 1. Where the computing system is a mobile apparatus, a battery may be additionally provided to supply operation voltage of the computing system.

It will be apparent to those of ordinary skill in the art that the computing system according to example embodiments may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A memory device, comprising:
a flash memory including a plurality of pages;
a non-volatile random access memory (RAM) storing a first mapping table between a physical page address and a logical page address for each page of the plurality of pages; and
a volatile RAM storing a second mapping table between the physical page address and the logical page address for each page of the plurality of pages.

2. The memory device of claim 1, wherein the first mapping table is used for converting the physical page address into the logical page address, and the second mapping table is used for converting the logical page address into the physical page address.

3. The memory device of claim 2, wherein the first mapping table is arranged according to the physical page address, and the second mapping table is arranged according to the logical page address.

4. The memory device of claim 1, wherein the second mapping table is generated by reconstructing the first mapping table.

5. The memory device of claim 4, wherein, in response to the memory device being booted up, the first mapping table is read from the non-volatile RAM and reconstructed to generate the second mapping table, and the second mapping table is stored in the volatile RAM.

6. The memory device of claim 2, wherein, in response to first data stored in a first page of the plurality of pages being updated:
second data which is an updated value of the first data is stored in a second page in the flash memory, the second page being empty prior to the storing of the second data, and
a logical address of the first page is stored as a logical address corresponding to a physical address of the second page in the first mapping table.

7. The memory device of claim 6, wherein a physical address corresponding to the logical address of the first page, the physical address being in the second mapping table, is converted from the physical address of the first page into the physical address of the second page.

8. The memory device of claim 1, wherein:
the non-volatile RAM is selected from a group consisting of phase change random access memory (PRAM) and ferromagnetic random access memory (FRAM), and
the volatile RAM is dynamic random access memory (DRAM).

9. The memory device of claim 1, wherein, in response to an erase count of the non-volatile RAM being determined, an erase count of the flash memory stored in the flash memory is determined as an erase count of the non-volatile RAM.

10. The memory device of claim 9, wherein the non-volatile RAM is PRAM.

11. The memory device of claim 1, wherein:
the flash memory includes a plurality of blocks and each of the plurality of blocks includes a plurality of pages, and
in response to a first block and a second block from among the plurality of the blocks being merged, the flash memory assigns a third block, the third block being empty, and respectively stores data for each valid page of the first block and data for each valid page of the second block in a plurality of pages of the third block.

12. The memory device of claim 11, wherein:
the memory device stores “NULL” to indicate that information for a logical address corresponding to a physical address for each valid page of the first block in the first mapping table does not exist,
the memory device stores “NULL” to indicate that information for a logical address corresponding to a physical address for each valid page of the second block in the first mapping table does not exist, and
the memory device determines and stores a value corresponding to a physical address for each page of the third block in the first mapping table based on a logical address for each valid page of the first block and a logical address for each valid page in the second block.

13. A memory device, comprising:
a flash memory including a plurality of data blocks and at least one metadata block, wherein the flash memory stores first metadata corresponding to the plurality of data blocks in the metadata block, and each of the plurality of data blocks include a plurality of pages; and
a non-volatile RAM storing second metadata corresponding to the plurality of data blocks,
wherein an erase count of the non-volatile RAM is determined by the first metadata.

14. The memory device of claim 13, wherein the first metadata includes an erase count for each of the plurality of data blocks, and the second metadata includes a first mapping table between a physical address and a logical address for each of the plurality of pages.

15. A method for managing a memory, the method comprising:
storing a first mapping table between a physical page address and a logical page address for each of a plurality of pages in a flash memory; and
generating a second mapping table between the physical page address and the logical page address for each of the plurality of pages by reconstructing the first mapping table read from the flash memory, in response to a memory device including the flash memory being booted up.

16. The method of claim 15, wherein the first mapping table is used for converting the physical page address into the logical page address, and the second mapping table is used for converting the logical page address into the physical page address.

17. The method of claim 15, wherein, in response to first data stored in a first page from among the plurality of pages being updated, the method further comprises:
storing second data which is an updated value of the first data in a second page of the flash memory, the second page being empty prior to the storing of the second data;
storing a logical address of the first page as a logical address corresponding to a physical address of the second page in the first mapping table; and
converting a physical address corresponding to the logical address of the first page, the physical address being in a second mapping table, from a physical address of the first page into the physical address of the second page.

18. The method of claim 15, wherein, in response to an erase count of a first word of the non-volatile RAM being determined, the method further comprises:
reading first metadata including an erase count of the flash memory;
searching for a first block corresponding to the first word from among the plurality of blocks of the flash memory using the first mapping table; and
determining an erase count of the first block as the erase count of the first word of the non-volatile RAM.

19. A computer-readable storage medium storing a program for managing a memory, comprising instructions to cause a computer to:
store a first mapping table between a physical page address and a logical page address for each of a plurality of pages in a flash memory; and
generate a second mapping table between the physical page address and the logical page address for each of the plurality of pages by reconstructing the first mapping table read from the flash memory, in response to a memory device including the flash memory being booted up.
